(19) United States
(12) Patent Application Publication
(10) Pub. No.: US 2016/0307211 A1
(43) Pub. Date: Oct. 20, 2016

(54) INFERRING CONTRIBUTIONS OF CONTENT TO MARKETING EVENTS

(71) Applicant: Linkedln Corporation, Mountain View, CA (US)

(72) Inventors: Wayne Pan, San Jose, CA (US); Nicholas David Snyder, Belmont, CA (US); William Jayang Sun, San Francisco, CA (US)

(21) Appl. No.: 14/700,898

(22) Filed: Apr. 30, 2015

Related U.S. Application Data
(60) Provisional application No. 62/148,051, filed on Apr. 15, 2015.

(51) Int. Cl. G06Q 30/02; G06N 5/04; G06N 99/00; H04L 29/08; G06Q 50/00

(52) U.S. Cl. CPC G06Q 30/0201; H04L 67/306; G06Q 50/01; G06N 99/005; G06N 5/04

(57) ABSTRACT

Disclosed in some examples are systems, methods, and machine readable mediums that infer contributions from content distributed on a hierarchical electronic content distribution system to the occurrence of events using observed interactions related to the content. For example, the system may infer that a particular item of content that was shared through the hierarchical electronic content distribution system caused a person to apply to the company seeking to be hired. As another example, the system may infer that a particular item of shared content caused or contributed to a sale of the company's products. As yet another example, the system may infer that a particular item of shared content caused or contributed to an increase in a metric associated with the organization.

### PRIORITY CLAIM

This patent application claims the benefit of priority, under 35 U.S.C. Section 119 to U.S. Provisional Patent Application Ser. No. 62/148,051, entitled “Inferring Contributions of Content Distributed Through a Hierarchical Content Distribution System to the Occurrence of Events,” filed on Apr. 15, 2015, which is hereby incorporated by reference herein in its entirety.

### BACKGROUND

A social networking service is a computer or web-based service that enables users to establish links or connections with persons for the purpose of sharing information with one another. Some social network services aim to enable friends and family to communicate and share with one another, while others are specifically directed to business users with a goal of facilitating the establishment of professional networks and the sharing of business information. For purposes of the present disclosure, the terms “social network” and “social networking service” are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks” or “professional networks”).

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a flowchart of a method of attributing an event to one or more items of content according to some examples of the present disclosure.

FIG. 2 is a diagram of a social networking service according to some examples of the present disclosure.

FIG. 3 is a block diagram illustrating an example of a machine upon which one or more embodiments may be implemented according to some examples of the present disclosure.

### DETAILED DESCRIPTION

In the following, a detailed description of examples will be given with references to the drawings. It should be understood that various modifications to the examples may be made. In particular, elements of one example may be combined and used in other examples to form new examples.

Many of the examples described herein are provided in the context of a social or business networking website or service. However, the applicability of the inventive subject matter is not limited to a social or business networking service. The present inventive subject matter is generally applicable to a wide range of information services.

A social networking service is a service provided by one or more computer systems accessible over a network that allows members of the service to build or reflect social networks or social relations among members. Typically, members construct profiles, which may include personal information such as the member's name, contact information, employment information, photographs, personal messages, status information, multimedia, links to web-related content, blogs, and so on. In order to build or reflect these social networks or social relations among members, the social networking service allows members to identify, and establish links or connections with other members. For instance, in the context of a business networking service (a type of social networking service), a member may establish a link or connection with his or her business contacts, including work colleagues, clients, customers, personal contacts, and so on. With a social networking service, a member may establish links or connections with his or her friends, family, or business contacts. While a social networking service and a business networking service may be generally described in terms of typical use cases (e.g., for personal and business networking respectively), it will be understood by one of ordinary skill in the art with the benefit of Applicant's disclosure that a business networking service may be used for personal purposes (e.g., connecting with friends, classmates, former classmates, and the like) as well as, or instead of, business networking purposes; and a social networking service may likewise be used for business networking purposes as well as or in place of social networking purposes. A connection may be formed using an invitation process in which one member “invites” a second member to form a link. The second member then has the option of accepting or declining the invitation.

In general, a connection or link represents or otherwise corresponds to an information access privilege, such that a first member who has established a connection with a second member is, via the establishment of that connection, authorizing the second member to view or access certain non-publicly available portions of their profiles that may include communications they have authored. Example communications may include blog posts, messages, “wall” postings, or the like. Of course, depending on the particular implementation of the business/social networking service, the nature and type of the information that may be shared, as well as the granularity with which the access privileges may be defined to protect certain types of data may vary.

Some social networking services may offer a subscription or “following” process to create a connection instead of, or in addition to the invitation process. A subscription or following model is where one member “follows” another member without the need for mutual agreement. Typically in this model, the follower is notified of public messages and other communications posted by the member that is followed. An example social networking service that follows this model is Twitter®—a micro-blogging service that allows members to follow other members without explicit permission. Other connection-based social networking services also may allow following-type relationships as well. For example, the social networking service LinkedIn® allows members to follow particular companies.

Members may be people or organizations (such as companies). Organizations may create profiles that may be visible to other members and may contain information about the organization, news, messages, and other communications from the organization and the like. Members may follow or connect with these organizations in the same way as they do other members. These organizational pages feature information about the organization and can serve as a powerful recruiting, marketing, and sales tool. An organization may recruit talent, generate interest in products, deliver news, and engage in other forms of advertising and marketing. While these pages offer a great way for an organization to accomplish its objectives, an organization's reach is limited to those who follow the company or who view the organization's profile page.

Individuals associated with the organization (e.g., employees of a company) offer untapped potential in reaching a larger audience. For example, the aggregate of all the connections of a company's employees are more numerous than just the followers of an organization. Individuals associated with the organization (such as employees) may have interests and goals aligned with those of the organization. Moreover, employees' connections may have similar goals and interests. As a consequence, employees' social connections may be a highly interested group that is receptive to the company's message.

In some examples, a social networking service may leverage these connections by utilizing a hierarchical electronic content distribution system to distribute content to a wider audience. In some examples, an individual associated with the organization (the content origin) may select an item of content and may select other individuals to share the content with. The selected individuals may be connections of the content origin and may or may not be associated with the organization. The individuals with whom the content origin shared the content may then share the content with some of their connections (both inside and outside the organization), and these connections may share the content with their connections (both inside and outside the organization), and so on.

In this way a hierarchical content distribution network may be created that is rooted at an organizational level, such as a company, and may utilize the connections of individuals associated with the organization, such as employees, their connections, and in some examples their connections' connections and so on in an effort to expand the company's influence.

In some examples, the content origin may be an employee of the organization whose job responsibilities include curating content for sharing in order to activate other employees to spread the company's message. In other examples, the content origin may be other employees.

The hierarchical content distribution network may be specific to each item of content. This is because each item of content may be shared with different associates, and those associates may share each item of content with different connections of theirs, and so on. Structurally, a hierarchical content distribution network may be described by a graph data structure (e.g., a tree) which is referred to herein for convenience of description as a content distribution graph. In this content distribution graph the top-level node in the graph represents the origin of the content. Nodes on the second-level represent members who are selected to receive the content by the top level node—e.g., selected employees. Third level nodes represent selected connections of second level nodes, and so on.

Nodes in the graph may represent people or other organizations. Nodes may be members of the “host” social networking service—that is, the social networking service which creates and manages the hierarchical content distribution network, or members of another social networking service. Each hierarchical content distribution network corresponds to an item of content, and each hierarchical content distribution network may be content specific, as each member of the hierarchical content distribution network may choose different connections to share different content with. In some examples, multiple hierarchical content distribution networks may exist for a single item of content if that item of content was shared initially by multiple content origins. In other examples, a single hierarchical content distribution network may exist for an item of content; if that item of content is shared by multiple origins, the content distribution graph may have multiple top-level nodes and may represent a merged graph of the path the content has taken through both organizations.

Each time a member shares an item of content with another member, a node may be added to the content distribution graph of that item of content. The nodes in the graph may store information on the members in the hierarchical content distribution graph. Such information may include one or more of an identifier of the member that is represented by the node, a link to the member's profile, a list of any interactions with the content, links to nodes that shared the content with this node and links to nodes that this node shared content with.

The recipient of the shared content may be notified via a notification, such as an email, a post to a news feed, a post on the member's profile, a mobile notification, or the like. Each recipient may “interact” with the content such as by opening, clicking, reading, commenting on, or sharing the content. Sharing and interacting with the content may be accomplished via a user interface provided by the social networking service (either the host social networking service, or another social networking service), or through other applications (that may be programmatically linked through an Application Programming Interface (API) to the social networking service).

Members of the hierarchical content distribution network may utilize one or more graphical user interfaces to participate in the hierarchical content distribution network that may be collectively referred to herein as a content sharing interface. The content sharing interfaces may be the same for each level in the hierarchy, or they may be different depending on the level (e.g., the interface presented to members at the first-level may be the same as, or different than, that presented to the second-level, and so on). These content sharing interfaces may be provided by the social networking service, by one or more other applications, or a combination of both. Content sharing interfaces may provide for the sharing of content, but may also provide for interactions by members with the content, including for example, clicking on the content, marking the content as a favorite, liking the content, commenting on the content, highlighting portions of the content, copying, pasting, or reading the content. In some examples, when sharing the content, individuals may include additional content such as comments, additions, photos, videos, sound clips, podcasts, and the like. These changes may be recorded in the content distribution graph. In some examples, the content sharing interfaces may be integrated into the social networking service—such as part of a member profile page.

The content sharing interface for each node may programmatically associate through one or more Application Programming Interfaces with other social networking services to present an individual with connections outside the host social networking service with which the content may be shared. Thus, each node in the content distribution graph may represent a member of the host social networking service (the social networking service providing the content distribution hierarchy) or may represent a member of a different social networking service.

The hierarchical electronic content distribution system may allow for the creation of channels. Channels are groups of one or more members (e.g., employees) that focus on sharing content that is of a particular subject matter. Members may publish one or more content shares to all the members who subscribe to a particular channel.

In some examples, the host social networking service may track the movement, changes, and interactions with content through the hierarchical content distribution network. For example, the content sharing interfaces may record in the content distribution graph which individuals have shared content, which individuals have interacted with the content, and the type of those interactions. For example, the system may track one or more content interactions such as: clicks of the content, re-shares of the content (e.g., when a connection re-shares the content with someone else), replies to the content, comments associated with the content, likes of the content, any tagging of the content (e.g., tagging the content as a “favorite”), and the like. The content interactions may be collected for any individuals, and the system may store an indication as to which individuals performed which interactions. These interactions may be collected through the content sharing interfaces, or through one or more other applications that are programmatically linked using an API to the social networking service.

The system may aggregate these interactions into one or more statistics. For example, the number of interactions, number of interactions broken down by type, the number of shares, number of clicks, number of views, number of tags, the engagements with the content, and the like. The statistics may be a total for all individuals, or may be broken down based upon hierarchy level (e.g., how many second level node shares, how many third level shares, and the like.) These statistics may be presented to other individuals, such as the individuals represented by the first-level nodes (e.g., organizational decision makers). Other statistics may include reach—the total network size of all individuals who could have seen a share; and a share rate—the percentage of employees of an organization who choose to share a broadcast with their networks.

While these statistics may give organizations information on popular and influential content, they do not directly measure the impact of a content communication on the achievement of an organization's goals. For example, a popular piece of content may not directly lead to sales of a product, the hiring of an employee, or the like.

Disclosed in some examples are systems, methods, and machine-readable mediums that infer contributions from content distributed on a hierarchical electronic content distribution system to the occurrence of events using observed interactions related to the content. For example, the system may infer that a particular item of content that was shared through the hierarchical electronic content distribution system caused a person to apply to the company seeking to be hired. The system may make this inference based upon observed interactions between the person and the item of content. As another example, the system may infer that a particular item of shared content caused or contributed to a sale of the company's products. In some examples, the inference may be a probability. In some examples, multiple items of content may be inferred to contribute to the event, and the system may assign percentages or weights to judge the particular contribution of each item of content to the occurrence of the event. In addition to, or instead of using observed interactions with the item of content, other features, such as information about the content itself, may be utilized in making these inferences.

In some examples, observed interactions may describe any interaction the recipient of the content has with the content. Examples may include interactions in which the recipient expresses interest in the content—such as by clicking on the content, reading the content, scrolling through the content, tagging the content, sharing the content, clicking links in the content, copying the content, printing the content, emailing the content, posting the content, commenting on the content, and the like. Examples may also include activities in which the recipient expresses dis-interest in the content—such as by ignoring the content, deleting the content, and the like. Interactions in which the recipient expresses interest in the content may increase the probability that the content caused the event, while interactions in which the recipient expresses dis-interest in the content may lower the probability that the content caused the event.

Interactions may be observed by monitoring the user through the interface provided by the social networking service and presented to the recipient in order to view or share the content (e.g., the content sharing interfaces). In other examples, the content may be presented on other platforms and through other programs. In these examples, the social networking service may observe the activities of the recipient through one or more other ways. For example, the social networking service may request to install, or already have installed, a local application executing on the recipient's computing device which may monitor the recipient's interactions with the content. In other examples, the content may have tracking images embedded (e.g., for determining viewing or reading), code such as JavaScript embedded (for tracking other behavior), or the like. In still other examples, the social networking service may interface with other programs used to access the content (e.g., a PDF reader) through an application programming interface. In general, the interaction tracking may be implemented automatically and without manual intervention. In other examples, interaction tracking may be assisted through manual surveys which may ask the recipient what activities they engaged in with the content.

Events may be broadly characterized as sales events, marketing events, or talent-related events. Marketing involves efforts to find potential buyers for products or services and to generate leads. For example, marketing is the action or business of promoting and selling products or services, including market research and advertising. Sales is taking the leads generated by marketing and actually closing the deal by selling a product. Talent-related events include attracting and retaining employees. In some examples, the occurrence of events may be observed through interfaces provided by the social networking service, through observations of changes in a member's status on the social networking service (e.g., the member indicates they have changed jobs), through other applications that are programmatically linked to the social networking service, and the like.

Events may have one or more members, individuals, or organizations that are involved in the event. For convenience these may be labeled “event participants.” In some examples, events have participants who are the focus of the event. For ease of description, these participants may be labeled as “targets” of the event. For example, if an employee leaves company X for company Y, the event has three participants: company X, company Y and the employee, and the employee is the target. Other example events are disclosed below.

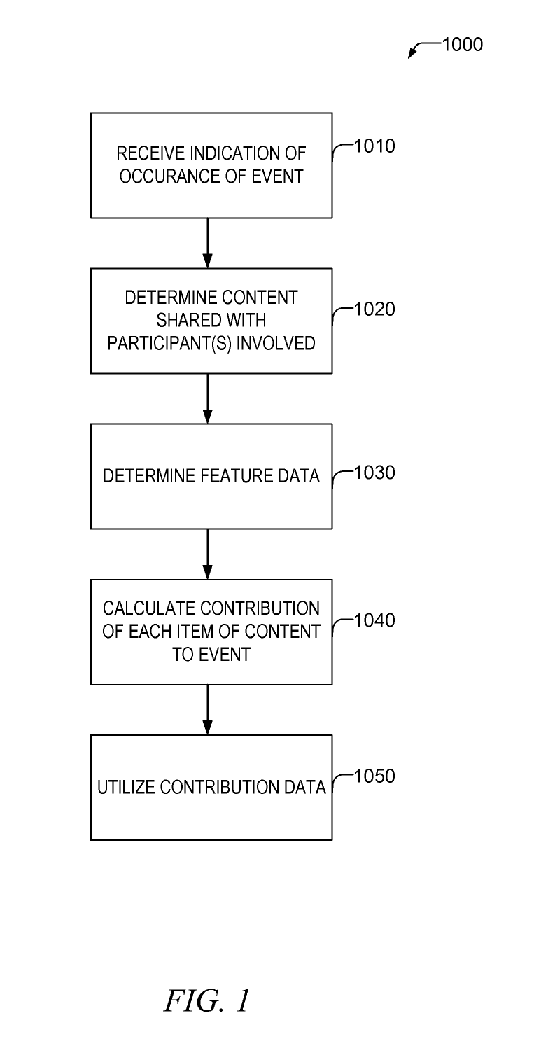

Turning now to FIG. 1, an example method 1000 of inferring events from observed interactions related to content distributed through a hierarchical electronic content distribution system is shown according to some examples. At operation 1010 the social networking service may receive an indication of an event's occurrence. This may be an automatic determination if the event is of a type that can be automatically determined such as, for example, if a user applies for a job through the social networking service or through a linked application (e.g., linked through an application programming interface). In still other examples, changes to a member's social networking profile may indicate an event. For example, a user may update their current job on their social networking profile. In other examples, the social networking service may have one or more graphical user interfaces which allow members to input event occurrences manually.

At operation 1020 the social networking service may determine one or more items of content shared with one or more participants (e.g., the target) involved in the event. For example, content shared with the member that reported a new job. In some examples, this may be every item of content shared with the member, in other examples, only content shared recently (e.g., using a predetermined cutoff period) may be considered.

At operation 1030, feature data of the determined one or more items of content are determined. Feature data may include interaction data between the participants and the items of content. This interaction data may be collected and stored (in real time, near real time, or periodically) with the content distribution graph. In these examples, operation 1030 involves retrieving this information from the content distribution graph. For example, the data may be stored at the member node which describes the individual involved in the event. In other examples, this may include contacting, through an API, other computing platforms and requesting the interaction information. Feature data may also include metadata about the content sent (e.g., length, author, document topics, and the like), data about the event, interaction data of the target relative to the content, and the like.

At operation 1040, a contribution is calculated for each item of content identified in operation 1020 to the occurrence of the event identified at operation 1010. The contribution of an item of content to the event's occurrence may be determined manually. The participants in the event may be explicitly asked, through a graphical user interface, to identify which of the identified items of content (identified in operation 1020) contributed to the event. The social networking service may utilize these responses to conclude that the user was motivated by the selected one or more items of content. When using surveys in this manner, operation 1030 may not be performed.

In other examples, the contribution of an item of content to the event's occurrence may be determined automatically from the feature data that was collected at operation 1030. Features used to determine the contribution for a particular item of content may include user interaction data, metadata about the content sent (e.g., length, author, document topics, and the like), data about the event, interaction data of the target relative to the content, and the like.

Features may be any data point that indicates an increased or decreased probability that the item of content was responsible for the occurrence of an event. For example, the time that the content was shared relative to the time of the event may be utilized. Content shared with the contact soonest in time to the event may be weighted more heavily than content shared farther away in time. In some examples, content shared too long ago (e.g., more than a predetermined time interval prior to the time of the event) may receive no weight.

As another example, the feature data may include data about the subject matter of the item of content. A subject matter for each item of content sent to the event target may be compared with the subject matter of the event. Those items of content with a subject matter that is most similar to the subject matter of the event may be weighted more heavily than those that are dissimilar. Similarity may be measured using one or more algorithms. For example, the social networking service may utilize a list that contains all of the subject matters along with indications of which other subject matters are similar, and in some examples, how similar they are. Subject matter of the items of content may be preselected or entered by the content curator or other administrator of the organization or may be automatically determined by the social networking service, for example, through topical modeling algorithms such as singular value decomposition, the method of moments, non-negative matrix factorization, explicit semantic analysis, latent semantic analysis, latent Dirichlet process, and the like. Subject matter of the events may be setup by an administrator (e.g., certain events relate to certain subject matters) or may be determined based upon a set of rules. For example, if the event is a new sales contact, then the subject matter may be interest in a certain line of products sold by the company. The line of products may be determined manually (e.g., entered by the organization) or automatically by the social networking service.

Other example features that may indicate an increased or decreased likelihood that a particular item of content was responsible for the occurrence of an event may include interactions with the items of content by participants in the event. For example, positive interactions such as clicks, likes, comments, submission of forms in the content, clicking on a “connect” button in the content, and the like may all be positive interactions that the user is interested in the content. Positive interactions are signs that may make the item of content more likely to be the cause of the occurrence of the event. Similarly, negative interactions such as deleting the content, marking the content as spam (e.g., unwanted and unsolicited messages), disliking it, and the like may be indications that the user is not interested in the content. Negative interactions with an item of content are indications that the item of content is less likely to be the cause of the occurrence of the event. Another indication may be exclusivity, e.g., an item of content that was the only item of content shared with the new contact may be weighted more heavily than if the item of content was one of many shared with the participant.

The features may be scored, weighted, and then summed to produce a total score for that particular item of content (e.g., a weighted sum algorithm). This score gives a likelihood (e.g., a probability) that a particular item of content was responsible for the event. Each factor may be converted to a numerical value, then multiplied by a weighting factor and summed to produce a final score. The one or more items of content with the highest scores may be inferred to be the reason for the event. In some examples, if no items of content score above a predetermined threshold, the occurrence of the event may not be attributed to any items of content.

Different weights may be applied to different features—e.g., each feature may be weighted in accordance with an expected contribution of that feature to attributing items of content to an event. Weights may be event-specific—that is, each event may have its own weighting values, or may be global.

To convert the features to a numerical value, different methods may be utilized. For example, points may be assigned to each instance of certain features (e.g., clicks, likes, comments, and the like). In other examples, different ranges of possible feature values may each have different points values. As an example, if the feature is a time comparison between when the content was shared and when the event occurred, the system may allocate 5 points for content that was shared the same day as the event, 4 points if the content was shared the same week, 3 points if the content was shared the same month, 2 points if the content was shared the same quarter as the event and so on. In yet other examples, other functions may be implemented to convert the feature to a score. Continuing with the time comparison between the content share and the event, this feature may instead be converted to points using a subtraction function; e.g., a time since the content was shared may be subtracted from a maximum time since the content was shared. This difference may then be subtracted from a maximum point value. A combination of the various methods for converting the features to scores may be utilized, with some features utilizing some methods while others utilize other, different methods.

Instead of utilizing weighted sums, other methods may be used to determine the contributions of each item of content to the occurrence of the event, such as various machine learning algorithms. For example, various regression algorithms may be utilized, such as linear regression, ordinary least squares, and non-parametric regression. Variables in the regression may include the feature data such as interaction information, information about the items of content (e.g., a predicted topic, time since it was sent, and the like), and other information. The output may be the predicted likelihood that a particular item of content contributed to the event. Each item of content identified by the system at operation 1020 may be processed by the regression algorithm, and the items that have the highest probabilities may be considered to be responsible for the event's occurrence. In some examples, if no items of content score above a predetermined threshold, the occurrence of the event may not be attributed to any items of content. The machine-learning model may be learned through one or more supervised or semi-supervised learning methods where training data may be generated based upon surveys given to event participants in which they explicitly identify the contributions of each piece of content that was shared with them to the event along with their content interaction history and other features (e.g., content topic) as set forth above.

Yet another example algorithm may include a decision tree algorithm. The decision tree may also utilize the feature information such as interaction and other information to make a decision as to the applicability of a particular item of content to the event. The decision tree may be built using training data as noted above for the regression algorithms. Example decision tree algorithms include Classification and Regression Tree (CART), Iterative Dichotomiser 3 (ID3), C4.5, Chi-squared Automatic Interaction Detection (CHAID), Decision Stump, Random Forest, Multivariate Adaptive Regression Splines (MARS), Gradient Boosting Machines (GBM), and the like. The output of the decision tree could be a yes or no which indicates that the content was at least partially responsible for the event or not. In other examples, the output of the decision tree could be a probability range (e.g., in 10% probability increments) that the content was responsible for the event. The results of the decision tree for each item of content may then be compared to determine the items of content that are most responsible. For example, if there are three items of content, and the decision tree outputs probability ranges, the system may utilize a threshold probability to select the content most likely responsible for the event.

Further example algorithms used to infer a contribution of an item of content to the occurrence of an event may include other machine learning algorithms such as Bayesian inference algorithms, and neural networks, which may be built using the same training data as disclosed above for the regression algorithms.

In some examples, at operation 1050, the output of the contribution process may be utilized. In some examples, the content deemed most responsible for the occurrence of an event may be displayed to one or more users of the content distribution network. As another example, the calculated contributions may be utilized as an input to other processes, such as recommendation processes of the social networking service. Sharing content that generates certain types of events (e.g., sales leads, desirable employees joining the organization, sales, and the like) may be desirable for an organization. Using the inferences generated at operation 1040, the social networking service may recommend sharing content similar to one or more items of content deemed responsible for the occurrence of the event in an effort to repeat that event (e.g., another sale, another job hire, and the like). In other examples, the system may generate recommendations for contacts, leads, potential employees, and the like based upon similar interaction data for users that are similar to a participant (e.g., the user who joined the company, the new sales lead, and the like) of an event.

The following discussion describes three categories of events. One of ordinary skill in the art with the benefit of Applicant's disclosure would recognize that the inventive concepts herein are not limited to these categories. Following the discussion of the three categories, examples will be given on how the contribution data may be utilized to enhance the hierarchical content distribution system of the social networking service.

### Sales Events

In some examples, the events may include sales-related events. Sales-related events may be any event that evidences an identifiable interest in the organization's products or services. Example sales-related events include events related to the tasks of tracking and managing sales leads and the selling of products. Leads are individuals or organizations that are potential customers for an organization's products or services. Specific example events include the creation of a new sales lead and sales of a product.

In some examples, the social networking service may provide one or more sales management interfaces that provide tools to manage leads, obtain information about leads, and introduce users to leads. These interfaces may allow salespersons to send messages to potential leads and to allow potential leads to show interest in an organization. The sales-related events in these examples may be tracked via the social networking service's sales management interfaces. In these interfaces, leads may be manually entered by a salesperson, or automatically when a lead expresses interest in the organization on the social networking service, e.g., through a lead contacting a sales person.

In additional examples, the social networking service's sales management interfaces may track sales-related events such as purchases of the organization's products. For example, the organization may input sales information into the sales management interface provided by the social networking service, or the sales management interface may allow for the online sales of products.

The social networking service may be notified of sales-related events in other ways, in addition to, or instead of through sales management interfaces. For example, the social networking service may share information using one or more APIs with external sales management software. The social networking service may be notified of a new lead event by the internal and/or external sales management software and, in response, may determine if the new lead was the result of a content share. For product sales events, the social networking service may be linked programmatically through one or more APIs to online sales software or to one or more electronic marketplaces (e.g., Amazon.com, eBay.com, and the like).

Other sales-related events may be attributed to one or more items of content by the social networking service such as, for example, a user that is not affiliated with the organization: following the organization, sending a message to the organization, expressing interest in the organization's products, purchases of the organization's products and services, or the like. These behaviors express an interest in the organization's products or services and may signal the user is a lead candidate. These events may be tracked by the social networking service as part of providing the social networking service.

### Talent Events

In some examples, the events may include talent-related events. Talent-related events may be any event surrounding recruiting and retaining of employees. For example, talent-related events may include events where the participants evidences an interest in working for the organization, such as an applicant applying for a job opening, an applicant becoming an employee, and the like.

In some examples, social networks may have talent management interfaces that recruiters may utilize to find, track, and manage qualified candidates for job openings. These interfaces may allow recruiters to send messages to applicants and to allow applicants to apply for positions. The talent-related events in these examples may be tracked via the social networking service's talent management interfaces. The events may be manually entered by a talent specialist with the organization, or automatically when the prospect applies through the social networking service.

The social networking service may be notified of talent-related events in other ways, in addition to, or instead of through talent management interfaces. For example, the social networking service may determine that a member has changed jobs based upon their social networking profile. The social networking service may also receive notification of talent-related events through communication with a third party talent management application through an application programming interface (API).

Other talent-related events include a participant leaving an organization, job application page views, interactions with one or more messages from recruiters of the organization, and the like. These events may be tracked through the social networking service, or one or more external applications through an API.

### Marketing Events

In some examples, the events may include marketing-related events. A marketing-related event may be any event that evidences an indirect interest in an organization's products or services. Marketing-related events may include positive increases in metrics corresponding to an organization's communications presence such as a website or member page. Increases in metrics include an increase in visitors to an organization's communications presence, an increase in page views per visitor, an increase in visits per visitor, interactions of visitors with elements in either of these sites, clicks, page views, connection requests, and the like. Other events may include product or organization mentions in blog posts, other content items, a social network feed, news, and the like. Participants may include members that click on the page, view pages, and the like.

In some examples, social networking services may have marketing management interfaces that aim to allow organizations to deliver the right content to the right people to boost sales leads and to build their brands. Example functionality may include advertisement targeting, sponsored messages, and other forms of advertising. In these examples, the shared content may be or include one or more advertisements or marketing campaigns. Metrics tracking website and profile view statistics may be analyzed periodically and positive increases that are above a threshold may trigger an investigation into which content may have contributed to that increase. Other content that is similar to the content that contributed to that increase may then be recommended to the organization as a way to further increase that metric.

Marketing events may be tracked using these marketing platforms, or may be tracked utilizing a third party marketing platform by communicating with the third party marketing platform using an application programming interface (API). Marketing events may be tracked by the social networking service when providing the social networking service functionality.

Since marketing events may have more participants than other types of events, the operations of FIG. 1 may be run on a larger scale—e.g., all participants (e.g., all users who viewed an organization's profile site) and all content shared with those participants may be processed according to FIG. 1. The content that scored the highest may be deemed to be the content that at least partially caused the occurrence of the event. In some examples, if no items of content score above a predetermined threshold, the occurrence of the event may not be attributed to any items of content. In some examples, because of the potentially large scale, various optimizations may be done. For example, rather than perform the operations of FIG. 1 on all content shared with all participants, a limited set of content is run through the operations of FIG. 1. In one example, the members of this limited set may be the content that was shared the most among the participants. Other selection methods may be utilized to reduce the processing complexity to attribute one or more items of content to the occurrence of an event. Also, while these limits are discussed herein for the marketing events, one of ordinary skill would understand that such limiting methods could be utilized with any event.

### Other Events

Other events may be attributable at least partially to one or more items of content that were shared to one or more event participants. In some examples, the social networking service may restrict direct communications to other members to connections of that member. The social networking service may then allow certain individuals to bypass this restriction (e.g., by paying a fee). This bypass method may be utilized to recruit employment candidates, advertise, convert sales leads, and the like. The systems and methods described herein may be utilized to attribute one or more interactions with these messages (e.g., opening them) to some other item of content that was previously shared with the target of these communications.

Other example events that may be attributed to an item of content include a connection request, following of a company's page, viewing a member or organization's profile, endorsing a skill of an individual associated with the organization, sending a message to an individual associated with the organization, and the like.

### Applications for Using the Contribution Information

In FIG. 1 and the above description, at operation 1050 the system optionally utilizes the contribution data. The following is a detailed description of possible utilizations of the contribution data. In some examples, the social networking service may display the estimated contributions for one or more items of content for one or more events in a graphical user interface. One item of content may be at least partially responsible for more than one event. This display may be part of the content sharing interfaces, or on another graphical user interface presented by the social networking service.

Various statistics may be calculated which may measure an impact of an item of content (e.g., items of content which are responsible for the most number of desirable events), and the like. These statistics may be displayed and presented to one or more of the individuals described in the content hierarchy. For example, an impact score may be calculated which measures the total impact an item of content has on producing one or more types of events. The impact score may be a sum of all the scores for the events that the item of content was attributed to have caused. Other statistics may focus on individual members of the hierarchical content distribution network such as, for example, which employee's content shares were most impactful, and the like.

In some examples, the attribution inferences generated by the social networking service may be utilized to recommend items of content to a curator of an organization or other user. For example, a document which is inferred to have been responsible for a desirable event may be analyzed using various algorithms (e.g., text analysis algorithms). This document may be compared with new items of content that haven't been shared yet. New items of content that are most similar to those that have been inferred to be responsible for the desirable event may be recommended to a curator of an organization for sharing. For example, Term Frequency-Inverse Document Frequencies (TF-IDF) of two documents may be used as vectors to a cosine similarity algorithm that outputs a measure of the similarity of the vectors (and thus the similarity of the documents). Other similarity algorithms may be used such as Jaccard similarity, Longest Common Substring (LCS), Latent Semantic Analysis (LSA), and the like.

This concept may be expanded such that a large corpus of documents that are determined to be proficient in contributing to a desirable event may be utilized to create a very accurate model which can then be utilized to recommend new content. For example, the top predetermined percentage of documents at producing a desired event over a particular period of time may be collected into an exemplary set of documents. The TF-IDF vectors of each document in the exemplary set may be combined such that new documents are compared to the entire exemplary set.

In other examples, both high scoring and low scoring content may be used to construct a model. For example, learning-to-rank machine learning algorithms (e.g., Combined Regression and Ranking, IntervalRank, GBlend, BayesRank, and the like) may be employed which utilize features derived from previously shared content (such as a TF-IDF vector), along with the calculated probability that they produced a particular desired past event to build a model which may be applied to predicting a score for new content. The score may be a prediction of the likelihood that the new content may produce a particular event. The social networking service may calculate the features of the new content (e.g., TF-IDF) and then produce an expected score for that content. High scoring content may then be suggested for the curator of an organization. In some examples, if no items of content score above a predetermined threshold, no items of content may be recommended. Likewise, in some examples, items of content that do not meet a predetermined threshold may also not be utilized in the model.

A single model may be built for the entire social networking service, for each organization, for each group of first-level nodes, or any desired granularity. Multiple models may even be built and results from each module may be presented to the organization's curator for selection of new share content.

New content may be input to the model for analysis as a result of action on the part of an individual associated with the organization. In other examples, the social networking service may crawl the internet or other network looking for content which the model predicts may have cause the occurrence of an event.

While in some examples, the characteristics of the content may be solely responsible for the occurrence of an event, in other examples, characteristics of the participants in the event may also play a role in the occurrence of an event. The model may be expanded to include characteristics of event participants as one of the observed features when the model is built.

Another utilization of the contribution data may be as input to a process to recommend additional sales leads. For example, the system may recommend, as additional sales leads, other members of one or more hierarchical content distribution networks who have similar or the same interactions with one or more similar or the same items of content to the interactions and items of content interacted with by the new sales lead. Similarity of content may be determined as noted above. Similarity in interactions may be determined by algorithms, such as cosine similarity where the features are utilized as the vectors. Recommended sales leads may be displayed in one or more user interfaces presented by the social networking service.

In some examples, the inferences calculated may be utilized as input to recommend additional talent leads. For example, the system may recommend, as additional talent leads, other members of one or more hierarchical content distribution networks who have similar or the same interactions with one or more similar or the same items of content to the interactions and items of content interacted with by the new talent lead. Similarity of content may be determined as noted above. Similarity in interactions may be determined by algorithms, such as cosine similarity, where the features are utilized as the vectors. Recommended talent leads may be displayed in one or more user interfaces presented by the social networking service.

In some examples, the inferences calculated may be utilized as input to recommend additional advertising targets. For example, the system may recommend, as additional advertising targets, other members of one or more hierarchical content distribution networks who have similar or the same interactions with one or more similar or the same items of content to the interactions and items of content interacted with by the advertising event. Similarity of content may be determined as noted above. Similarity in interactions may be determined by algorithms such as cosine similarity where the features are utilized as the vectors. Recommended advertising targets may be displayed in one or more user interfaces presented by the social networking service.

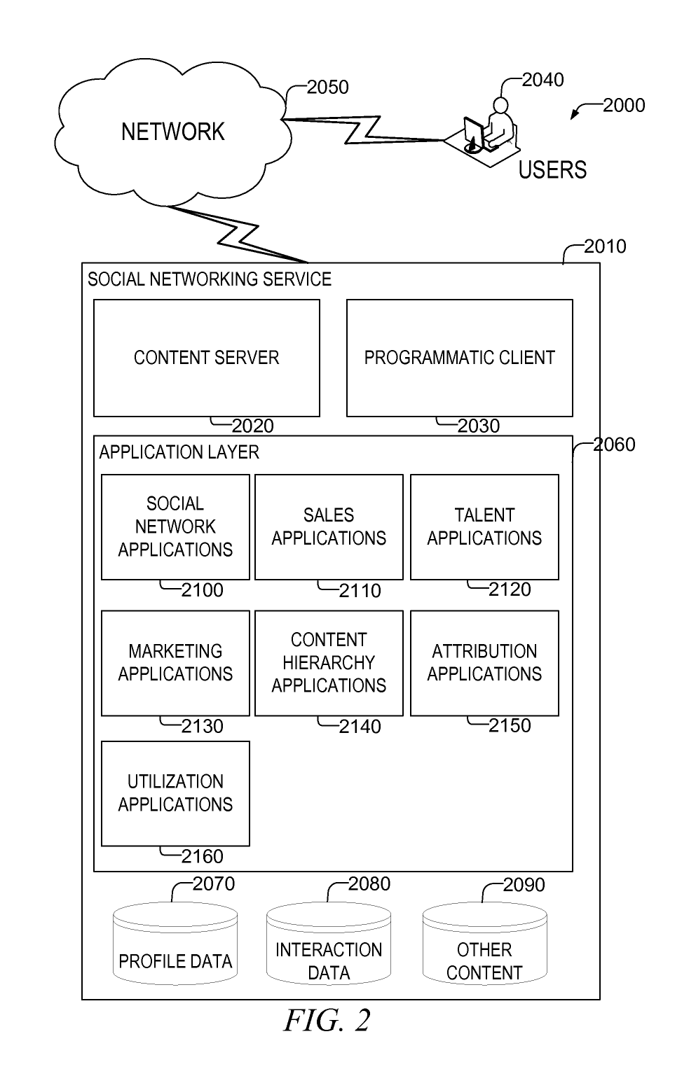

FIG. 2 shows a diagram of a social network system 2000 according to some examples of the present disclosure. Social networking service 2010 may contain a content server 2020. Content server 2020 may receive requests from various client computing devices (such as a device operated by a user 2040) over a network 2050 and communicate appropriate responses to the requesting client computing devices. In an embodiment, content server 2020 may receive requests in the form of Hypertext Transport Protocol (HTTP) messages. Content server 2020, in one example, may include or be a web server that fetches or creates internet web pages. Web pages may be or include Hyper Text Markup Language (HTML), eXtensible Markup Language (XML), JavaScript, or the like. The web pages may include portions of, or all of, one or more member profiles of the social networking service and may be or include the graphical user interface of the social networking service. Content server 2020 may communicate with one or more application layer modules 2060 and/or data stores (e.g., profile data store 2070, interaction data store 2080, other content data store 2090) to provide requested content to users (e.g., user 2040) upon request.

A programmatic client 2030 may provide one or more application programming interfaces (APIs) which may provide an interface for external applications to communicate with the social networking service 2010. The programmatic client may work with the application layer 2060, profile data store 2070, interaction data store 2080 and other content data store 2090 processes to provide a response to requests for data from external applications. Both the content server module 2020 and programmatic client 2030 may implement appropriate authentication and access control to ensure that data is not given to unauthorized parties. The access control may be part of the programmatic client 2030 or the content server 2020 or may be part of the application layer 2060 (e.g., in the social network applications 2100) or the data stores 2070-2090.

The application layer 2060 may provide one or more applications which provide the functionality of the social networking service 2010. Applications in the application layer 2060 may communicate with one another, with the content server 2020, programmatic client 2030, and data stores 2070-2090.

Social network applications 2100 may provide social network interfaces accessible through and in conjunction with the content server 2020, programmatic client 2030, or both. Social network applications 2100 may utilize data from the profile data store 2070, interaction data store 2080, other content data store 2090, or some combination thereof. Social network applications 2100 may store data in the profile data store 2070, interaction data store 2080, other content data store 2090, or some combination thereof. Social network applications 2100 may provide, in conjunction with content server 2020, graphical user interfaces to allow users to create an account with the social networking service 2010, build a member profile, store the member profile in profile data store 2070, communicate with other members, make connections, follow other users, and other functions of a social networking service as described above. Social network applications 2100 may record one or more interactions of users with one or more objects on the social networking service. Example interactions may include member profile views, connections, page views, follows, likes, content shares, content interactions, and the like.

Data stores 2070, 2080, and 2090 may store profile data, interaction data, and other content. Other content data store 2090 may store articles, videos, graphics, animations, information on sales leads, talent leads, marketing information, feature data, and other data for applications in the application layer 2060. Interaction data may include information regarding member profile views, connections, page views, follows, likes, content shares, content interactions, and the like. Profile data may include name, age, education history, connections, employment history, skills, endorsements, and the like. In general profile data may be biographical information about a member of the social networking service 2010.

Sales applications 2110 may provide sales management interfaces accessible through and in conjunction with content server 2020, programmatic client 2030, or both. Sales applications 2110 may utilize data from profile data store 2070, interaction data store 2080, other content data store 2090, or some combination thereof. Sales applications 2110 may store data in profile data store 2070, interaction data store 2080, other content data store 2090, or some combination thereof. Sales applications 2110 may allow members to manage and track leads and contacts, get information about leads, and get introductions with leads that may be out of network to the member. Sales applications 2110 may generate one or more lead recommendations. Sales applications 2110 may be linked to one or more external services and may exchange information and data with those services over network 2050. For example, sales applications 2110 may import one or more contacts and address books from external email accounts. Sales applications 2110 may allow members to search for leads using advanced search functionality. For example, through the use of advanced functionality only available through the sales applications 2110 such as searching by seniority, company size, function, and more. Sales applications 2110 may deliver real-time updates about changes to the social networking data on leads that are tracked. Sales applications 2110 may leverage the social graph formed using the connections between members of the social networking service to find a connection that may introduce the member to a desired sales lead. Sales applications 2110 may allow users to access non-public portions of a member's profile, see information on who has viewed their own profiles, and the like. Sales applications 2110 may also allow users to send messages to members that are not their connections (which may not typically be allowed). Sales applications 2110 may allow for tracking and managing of sales of an organization's product or services.

Talent applications 2120 may provide talent management interfaces accessible through and in conjunction with content server 2020, programmatic client 2030, or both. Talent applications 2110 may utilize data from profile data store 2070, interaction data store 2080, other content data store 2090, or some combination thereof. Talent applications 2120 may store data in profile data store 2070, interaction data store 2080, other content data store 2090, or some combination thereof. Talent applications 2120 may provide services to allow organizations to find, recruit, and manage employees. Talent applications 2120 may allow users to search for and view candidates that are not connections. Talent applications 2120 may allow users access to advanced search functionality such as searching by seniority, company size, function, skills, and more. Talent applications 2120 may allow users to access non-public portions of a member's profile, see information on who has viewed their own profiles, and the like. Talent applications 2120 may also allow users to send messages to members that are not their connections (which may not typically be allowed). Talent applications 2120 may allow organizations to post, manage, and/or edit, one or more job openings on the social networking service. Talent applications 2120 may allow members to apply for those job openings. Talent applications 2120 may also allow members to manage their current employees. Talent applications 2120 may also contain advertising tools that may allow an organization to advertise a job opening to selected persons.

Marketing applications 2130 may provide marketing management interfaces accessible through and in conjunction with content server 2020, programmatic client 2030, or both. Marketing applications 2130 may utilize data from profile data store 2070, interaction data store 2080, other content data store 2090, or some combination thereof. Marketing applications 2130 may store data in profile data store 2070, interaction data store 2080, other content data store 2090, or some combination thereof. Marketing applications 2130 may enable users to deliver targeted advertising content to other members. For example, marketing applications 2130 may allow members to specify characteristics of members or anonymous users that are to receive their advertisements. Example characteristics may include any item of data in the member profiles (e.g., skills, location, geography), domain name, and the like. Marketing applications 2130 may provide users with the ability to schedule advertising campaigns and details about those campaigns. Marketing applications 2130 may allow users to post sponsored messages on member's profile pages. Marketing applications 2130 may allow users to send sponsored messages to other members even if the users are not connected to the targeted members.

Users (such as user 2040) of the social networking service 2010 may include one or more members, prospective members, or other users of the social networking service 2010. Users access the social networking service 2010 using one or more computing devices through network 2050. The network 2050 may be any means of enabling the social networking service 2010 to communicate data with computing devices of the users (e.g., user 2040). Example networks 2050 may be or include portions of one or more of: the Internet, a Local Area Network (LAN), a Wide Area Network (WAN), wireless network (such as a wireless network based upon an IEEE 802.11 family of standards), a Metropolitan Area Network (MAN), a cellular network, or the like.

Computing devices used by users (e.g., users 2040) to access the social networking service 2010 may be a laptop, desktop, tablet, cell phone or any other computing device which may allow a user 2040 to access social networking service 2010 either through a browser which may utilize content server 2020 or through a dedicated application which may utilize programmatic client 2030.

Social networking service 2010 may operate on one or more computing devices, such as for example, one or more server machines. Social networking service 2010 may be communicatively coupled to one or more other servers. Social networking service 2010 may be coupled to one or more data stores, such as profile data store 2070, interaction data store 2080, and other content data store 2090. Data stores may be or include physical storage and software such as a database to manage the data on the physical storage.

Content hierarchy applications 2140 may implement the hierarchical electronic content distribution system that allows members to create hierarchical content distribution networks through and in conjunction with content server 2020, programmatic client 2030, or both. Content hierarchy applications 2140 may utilize data from profile data store 2070, interaction data store 2080, other content data store 2090, or some combination thereof. Content hierarchy applications 2140 may store data in profile data store 2070, interaction data store 2080, other content data store 2090, or some combination thereof. Content hierarchy applications 2140 may track and store the content distribution graph and provide the content sharing interfaces. Content hierarchy applications 2140 may track interactions with shared content and keep statistics and information on shared content. Content may be stored in the other content data store 2090.

Attribution applications 2150 may attribute an event to one or more items of content shared through the content hierarchy applications 2140 in conjunction with content server 2020, programmatic client 2030, social network applications 2100, sales applications 2110, talent applications 2120, marketing applications 2130, content hierarchy applications 2140, or some combination. Attribution applications 2150 may utilize data from profile data store 2070, interaction data store 2080, other content data store 2090, or some combination thereof. Attribution applications 2150 may store data in profile data store 2070, interaction data store 2080, other content data store 2090, or some combination thereof. Attribution applications 2150 may utilize features such as interactions with the items of content, information about the items of content, and information about the event participants and the event to infer that one or more items of content were responsible for the occurrence of the event. For example, the attribution applications 2150 may execute the operations of FIG. 1. Attribution applications 2150 may learn one or more machine learning models. Attribution applications 2150 may provide one or more user interfaces in conjunction with content server 2020, programmatic client 2030, or both to provide information and statistics on attribution.

Utilization applications 2160 may utilize the attributions inferred by the attribution applications 2150 in conjunction with content server 2020, programmatic client 2030, social network applications 2100, sales applications 2110, talent applications 2120, marketing applications 2130, attribution applications 2150, content hierarchy applications 2140, or some combination. Utilization applications 2160 may utilize data from profile data store 2070, interaction data store 2080, other content data store 2090, or some combination thereof. Utilization applications 2160 may store data in profile data store 2070, interaction data store 2080, other content data store 2090, or some combination thereof. Utilization applications 2160 may provide information on attributions, make one or more recommendations based upon the attribution information generated by the attribution applications 2150, and the like. For example, the utilization applications 2160 may recommend items of content that are similar to previously shared items of content that were attributed to the occurrence of a desired event.

### Example Hardware and Machine Implementations

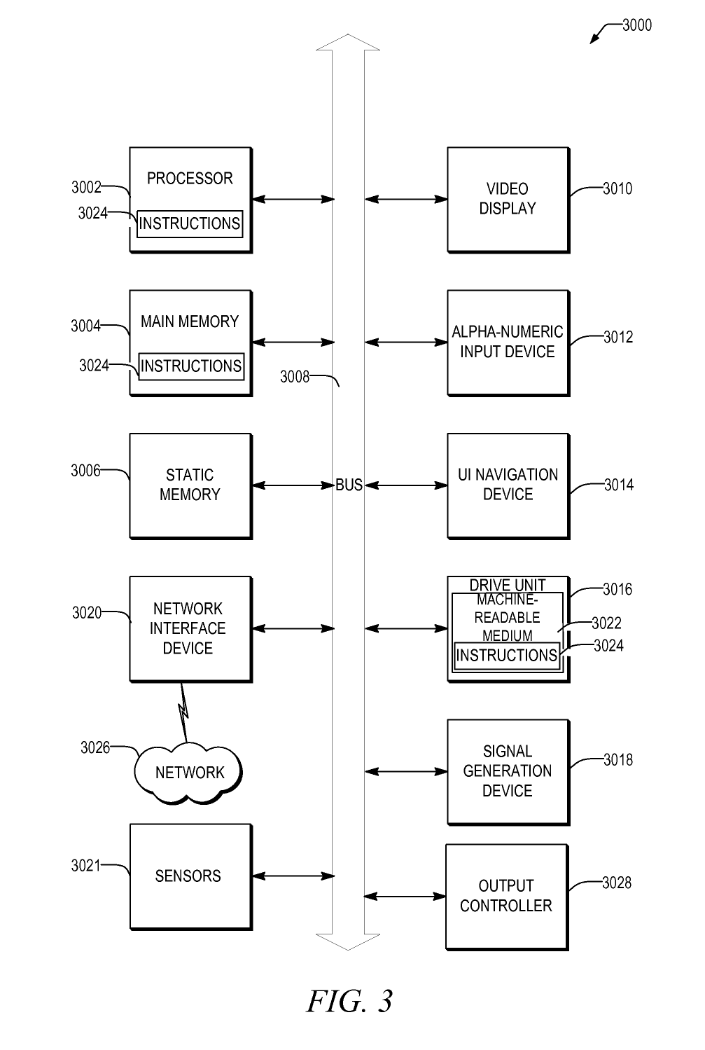

FIG. 3 illustrates a block diagram of an example machine 3000 upon which any one or more of the techniques (e.g., methodologies) discussed herein may perform. In alternative embodiments, the machine 3000 may operate as a standalone device or may be connected (e.g., networked) to other machines. In a networked deployment, the machine 3000 may operate in the capacity of a server machine, a client machine, or both in server-client network environments. In an example, the machine 3000 may act as a peer machine in peer-to-peer (P2P) (or other distributed) network environment. The applications of FIG. 2 may be executed on one or more machine(s) 3000. The machine 3000 may be, or be part of, a social networking system, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, applications or mechanisms. For example, the applications and processes of FIG. 2 may be implemented as one or more modules. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 3000 may include a hardware processor 3002 (e.g., a central processing unit (CPU), a graphics processing unit (GPU), a hardware processor core, or any combination thereof), a main memory 3004 and a static memory 3006, some or all of which may communicate with each other via an interlink (e.g., bus) 3008. The machine 3000 may further include a display unit 3010, an alphanumeric input device 3012 (e.g., a keyboard), and a user interface (UI) navigation device 3014 (e.g., a mouse). In an example, the display unit 3010, input device 3012 and UI navigation device 3014 may be a touch screen display. The machine 3000 may additionally include a storage device (e.g., drive unit) 3016, a signal generation device 3018 (e.g., a speaker), a network interface device 3020, and one or more sensors 3021, such as a global positioning system (GPS) sensor, compass, accelerometer, or other sensor. The machine 3000 may include an output controller 3028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 3016 may include a machine readable medium 3022 on which is stored one or more sets of data structures or instructions 3024 (e.g., software) embodying or utilized by any one or more of the techniques or functions described herein. The instructions 3024 may also reside, completely or at least partially, within the main memory 3004, within static memory 3006, or within the hardware processor 3002 during execution thereof by the machine 3000. In an example, one or any combination of the hardware processor 3002, the main memory 3004, the static memory 3006, or the storage device 3016 may constitute machine readable media.

While the machine readable medium 3022 is illustrated as a single medium, the term “machine readable medium” may include a single medium or multiple media (e.g., a centralized or distributed database, and/or associated caches and servers) configured to store the one or more instructions 3024.

The term “machine readable medium” may include any medium that is capable of storing, encoding, or carrying instructions for execution by the machine 3000 and that cause the machine 3000 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 3024 may further be transmitted or received over a communications network 3026 using a transmission medium via the network interface device 3020. The Machine 3000 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 3020 may include one or more physical jacks (e.g., Ethernet, coaxial, or phone jacks) or one or more antennas to connect to the communications network 3026. In an example, the network interface device 3020 may include a plurality of antennas to wirelessly communicate using at least one of single-input multiple-output (SIMO), multiple-input multiple-output (MIMO), or multiple-input single-output (MISO) techniques. In some examples, the network interface device 3020 may wirelessly communicate using Multiple User MIMO techniques.

What is claimed is:

1. A communication system comprising:
a social networking service comprising one or more computer processors to:
implement a hierarchical electronic content distribution system to create at least one hierarchical content network, the at least one hierarchical content network corresponding to an item of content;
receive an indication of an occurrence of a marketing-related event, wherein a participant in the marketing-related event is a member of the at least one hierarchical content network;
determine a feature corresponding to the item of content, the feature including at least one interaction between the participant and the item of content; and
based upon the feature, determine that the item of content at least partially contributed to the occurrence of the event.

2. The communication system of claim 1, wherein the marketing-related event is an increase in a metric corresponding to an organization's member page, and wherein the participant also interacted with the organization's member page.

3. The communication system of claim 2, wherein the increase in a metric corresponding to the organization's member page comprises one of: increase in page views, increase in page views per visitor, increase in visits per visitor, clicks, page views, or connection requests.

4. The communication system of claim 1, wherein the one or more processors are configured to implement the hierarchical electronic content distribution system by providing one or more graphical user interfaces to facilitate creation of the at least one hierarchical content network by providing an interface to allow members of the at least one hierarchical content network to share the item of content with other members of the social networking service to which they are connected.

5. The communication system of claim 1, wherein the one or more computer processors are configured to determine that the item of content at least partially contributed to the occurrence of the marketing-related event by at least being configured to determine a time correlation between a time of occurrence of at least one of the one or more interactions and a time of occurrence of the marketing-related event.

6. The communication system of claim 1, wherein the one or more computer processors are configured to determine that the item of content at least partially contributed to the occurrence of the marketing-related event by at least being configured to determine that a weighted sum for scores assigned to all the features was above a predetermined threshold score.

7. The communication system of claim 1, wherein
the one or more computer processors are configured to build a machine learning model using training data, the training data comprising a plurality of previous marketing-related events and manually tagged indications of which of a plurality of previously shared content caused the previous marketing-related events, and
wherein the one or more features includes metadata about the item of content, and wherein the one or more computer processors are configured to determine that the item of content at least partially contributed to the occurrence of the marketing-related event by at least being configured to use the machine learning model and the one or more features as inputs into a machine learning algorithm.

8. The communication system of claim 1, wherein the computer processors are configured to recommend a second item of content similar to the item of content responsive to determining that the item of content at least partially contributed to the occurrence of the marketing-related event.

9. A method comprising:
using one or more computer processors:
implementing a hierarchical electronic content distribution system to create at least one hierarchical content network, the at least one hierarchical content network corresponding to an item of content;
receiving an indication of an occurrence of a marketing-related event, wherein a participant in the marketing-related event is a member of the at least one hierarchical content network;
determining a feature corresponding to the item of content, the feature including at least one interaction between the participant and the item of content; and
based upon the feature, determining that the item of content at least partially contributed to the occurrence of the event.

10. The method of claim 9, wherein the marketing-related event is an increase in a metric corresponding to an organization's member page, and wherein the participant also interacted with the organization's member page.

11. The method of claim 10, wherein the increase in a metric corresponding to the organization's member page comprises one of: increase in page views, increase in page views per visitor, increase in visits per visitor, clicks, page views, or connection requests.

12. The method of claim 9, wherein implementing the hierarchical electronic content distribution system comprises providing one or more graphical user interfaces to facilitate creation of the at least one hierarchical content network by providing an interface to allow members of the at least one hierarchical content network to share the item of content with other members of a social networking service to which they are connected.

13. The method of claim 9, wherein determining that the item of content at least partially contributed to the occurrence of the marketing-related event comprises determining a time correlation between a time of occurrence of at least one of the one or more interactions and a time of occurrence of the marketing-related event.

14. The method of claim 9, wherein determining that the item of content at least partially contributed to the occurrence of the marketing-related event comprises determining that a weighted sum for scores assigned to all the features was above a predetermined threshold score.

15. The method of claim 9, comprising building a machine learning model using training data, the training data comprising a plurality of previous marketing-related events and manually tagged indications of which of a plurality of previously shared content caused the previous marketing-related events, and
wherein the one or more features includes metadata about the item of content, and wherein the determining that the item of content at least partially contributed to the occurrence of the marketing-related event comprises using the machine learning model and the one or more features as inputs into a machine learning algorithm.

16. The method of claim 9, comprising recommending a second item of content similar to the item of content responsive to determining that the item of content at least partially contributed to the occurrence of the marketing-related event.

17. A non-transitory machine-readable medium comprising instructions, which when performed by a machine, causes the machine to perform operations comprising:
implementing a hierarchical electronic content distribution system to create at least one hierarchical content network, the at least one hierarchical content network corresponding to an item of content;
receiving an indication of an occurrence of a marketing-related event, wherein a participant in the marketing-related event is a member of the at least one hierarchical content network;
determining a feature corresponding to the item of content, the feature including at least one interaction between the participant and the item of content; and
based upon the feature, determining that the item of content at least partially contributed to the occurrence of the event.

18. The non-transitory machine-readable medium of claim 17, wherein the marketing-related event is an increase in a metric corresponding to an organization's member page, and wherein the participant also interacted with the organization's member page.

19. The non-transitory machine-readable medium of claim 18, wherein the increase in a metric corresponding to the organization's member page comprises one of: increase in page views, increase in page views per visitor, increase in visits per visitor, clicks, page views, or connection requests.

20. The non-transitory machine-readable medium of claim 17, wherein the operations for implementing the hierarchical electronic content distribution system comprise operations for providing one or more graphical user interfaces to facilitate creation of the at least one hierarchical content network by providing an interface to allow members of the at least one hierarchical content network to share the item of content with other members of the social networking service to which they are connected.

21. The non-transitory machine-readable medium of claim 17, wherein the operations for determining that the item of content at least partially contributed to the occurrence of the marketing-related event comprise operations for determining a time correlation between a time of occurrence of at least one of the one or more interactions and a time of occurrence of the marketing-related event.

22. The non-transitory machine-readable medium of claim 17, wherein the operations for determining that the item of content at least partially contributed to the occurrence of the marketing-related event comprise operations for determining that a weighted sum for scores assigned to all the features was above a predetermined threshold score.

23. The non-transitory machine-readable medium of claim 17, wherein the operations comprise building a machine learning model using training data, the training data comprising a plurality of previous marketing-related events and manually tagged indications of which of a plurality of previously shared content caused the previous marketing-related events, and
wherein the one or more features includes metadata about the item of content, and wherein the operations for determining that the item of content at least partially contributed to the occurrence of the marketing-related event comprise operations for using the machine learning model and the one or more features as inputs into a machine learning algorithm.

24. The non-transitory machine-readable medium of claim 17, wherein the operations comprise recommending a second item of content similar to the item of content responsive to determining that the item of content at least partially contributed to the occurrence of the marketing-related event.
